(19) United States
(12) Patent Application Publication
(10) Pub. No.: US 2007/0053147 A1
(43) Pub. Date: Mar. 8, 2007

(54) PORTABLE COMPUTER

(75) Inventors: Zhi-Gang Liu, Shenzhen (CN); Hsuan-Chen Chen, Tu Cheng (TW); Chien-Li Tsai, Tu Cheng (TW); Wen-Kang Lo, Tu Cheng (TW); Ke-Cheng Lin, Tu Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., TU CHENG (TW)

(21) Appl. No.: 11/308,693

(22) Filed: Apr. 22, 2006

(30) Foreign Application Priority Data
Sep. 5, 2005 (CN) 200520064281.3

(51) Int. Cl. G06F 1/16

(52) U.S. Cl. 361/683

(57) ABSTRACT

A portable computer includes a base unit, and a cover unit. The base unit includes a chassis, a motherboard, and a base. The motherboard is attached to the chassis. The base engages with the chassis. The cover unit is pivotally connected to a rear portion of the base unit. The chassis includes a top plate. The top plate is adjacent to the cover unit when the portable computer is closed.

### FIELD OF THE INVENTION

The present invention relates to a portable computer, and more particularly to a portable computer which includes an expediently replaced base.

### DESCRIPTION OF RELATED ART

Portable computers, such as laptop computers and notebook computers, have become increasingly popular for general use. Some users assemble portable computers by themselves, thus the components, modules, and enclosure of portable computers need to be easily replaceable.

Generally, a portable computer includes a base unit with a base, and when the portable computer is put on a table, the external surface of the base touches the table top. A motherboard of the portable computer is contained within the base. As shown in FIG. 5, the portable computer includes a base unit 81, and a cover unit 82. The base unit 81 includes a top plate 811, a motherboard 813, and a base 815. A plurality of positioning posts 851 each defining a threaded hole protrudes from the base 815. A plurality of through holes 831 is defined in the edges of the motherboard 813 corresponding to the positioning posts 851 of the base 815. A plurality of screws 817 extends through the through holes 831 of the motherboard 813 engaging in the threaded holes of the positioning posts 851 respectively, thus the motherboard 813 is attached to the base 815. The top plate 811 engages with the base 815. The cover unit 82 is pivotally connected to a rear portion of the base unit 81. However, to replace the base 815, a user has to detach the top plate 811 and unscrew the screws 817 to separate the motherboard 813 from the base 815. The process is inconvenient and places the motherboard 813 at risk of being damaged.

What is desired, therefore, is a portable computer which includes an expediently replaceable base.

### SUMMARY OF THE INVENTION

In one preferred embodiment, a portable computer includes a base unit, and a cover unit. The base unit includes a chassis, a motherboard, and a base. The motherboard is attached to the chassis. The base engages with the chassis. The cover unit is pivotally connected to a rear portion of the base unit. The chassis includes a top plate. The cover unit fits over the top plate when the portable computer is closed.

To replace the base, a user can detach it from the chassis directly.

Other advantages and novel features will become more apparent from the following detailed description of preferred embodiments when taken in conjunction with the accompanying drawings, in which:

### BRIEF DESCRIPTION OF THE DRAWINGS

FIG. 1 is an exploded, inverted isometric view of a base unit of a portable computer, the base unit including a motherboard and a chassis in accordance with a preferred embodiment of the present invention;

FIG. 2 is similar to FIG. 1 but with the motherboard attached to the chassis;

FIG. 3 is an isometric view showing the assembled view of the base unit;

FIG. 4 is an assembled view of the portable computer; and

FIG. 5 is an exploded, isometric view of a conventional portable computer.

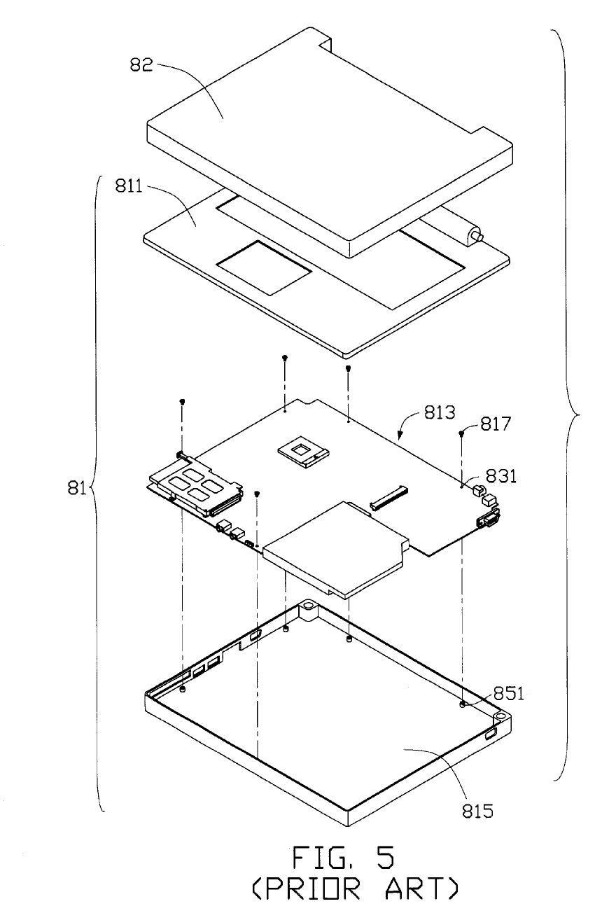

### DETAILED DESCRIPTION OF THE INVENTION

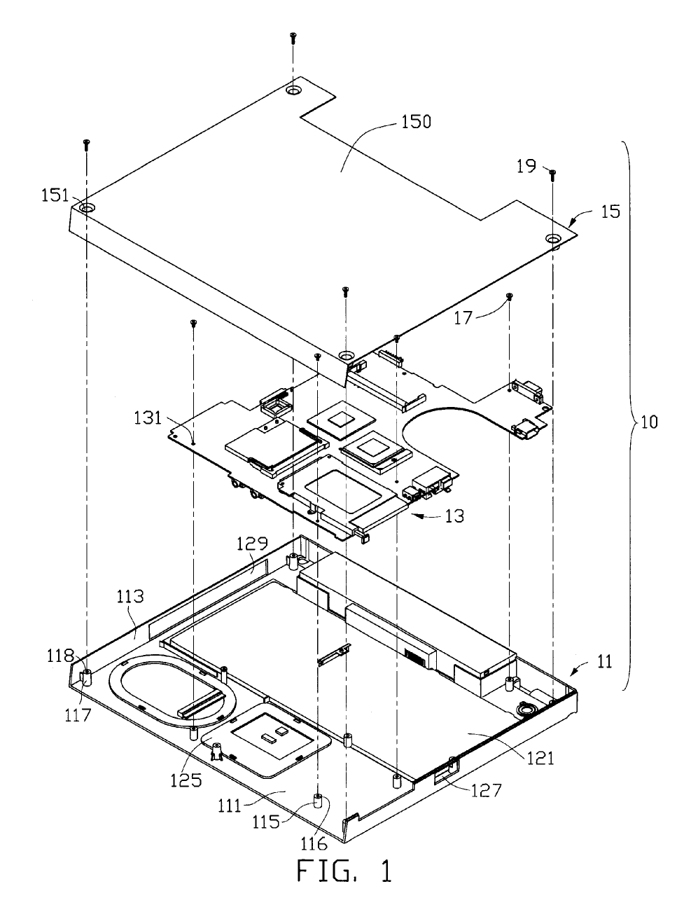

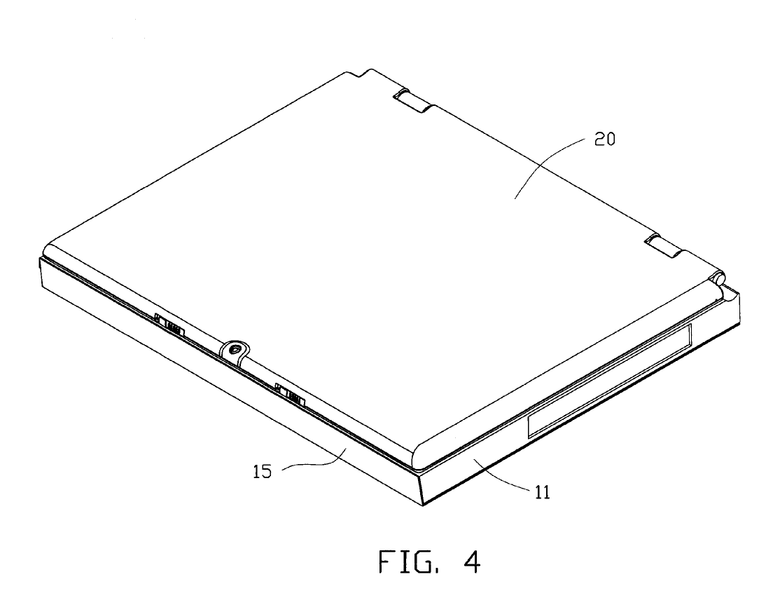

Referring to FIGS. 1 and 4, a portable computer in accordance with a preferred embodiment of the present invention includes a base unit 10, and a cover unit 20 pivotally connected to a rear portion of the base unit 10. The base unit 10 includes a chassis 11, a motherboard 13 attached to the chassis 11, and a base 15 engaging with the chassis 11.

The chassis 111 includes a top plate 111 and three side walls 113. A plurality of positioning posts 115 and retaining posts 117 protrude down from the top plate 111. Each positioning post 115 defines a threaded hole 116 in a free end thereof. Each retaining post 117 defines a threaded hole 118 in a free end thereof. The top plate 111 receives a plurality of Input devices, such as a keyboard 121 and a touchpad 125. When the portable computer is closed, the cover unit 20 fits over the top plate 111 of the chassis 11. The side walls 113 extend down from the edges of the top plate 111, and a plurality of access holes 127 for connecters and openings 129 for data storage devices are defined in the side walls 113.

A plurality of through holes 131 is defined in the motherboard 13, corresponding to the positioning posts 115 of the top plate 111.

The base 15 includes an external surface 150, and the external surface 150 touches the table top or lap of a user when the portable computer is being used. A plurality of stepped holes 151 is defined in the edges of the base 15, corresponding to the retaining posts 117 of the top plate 111.

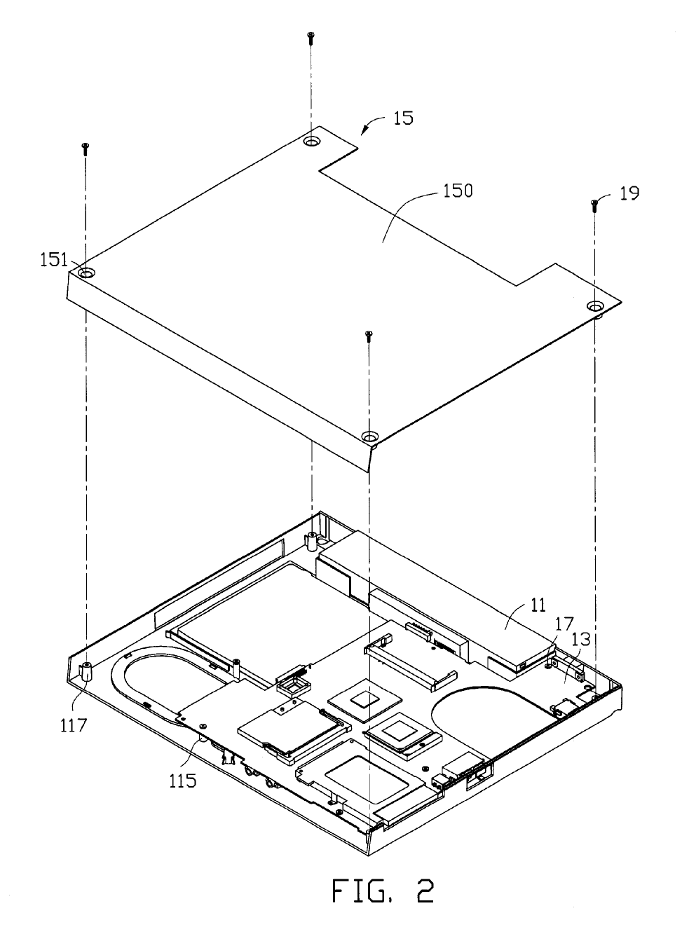

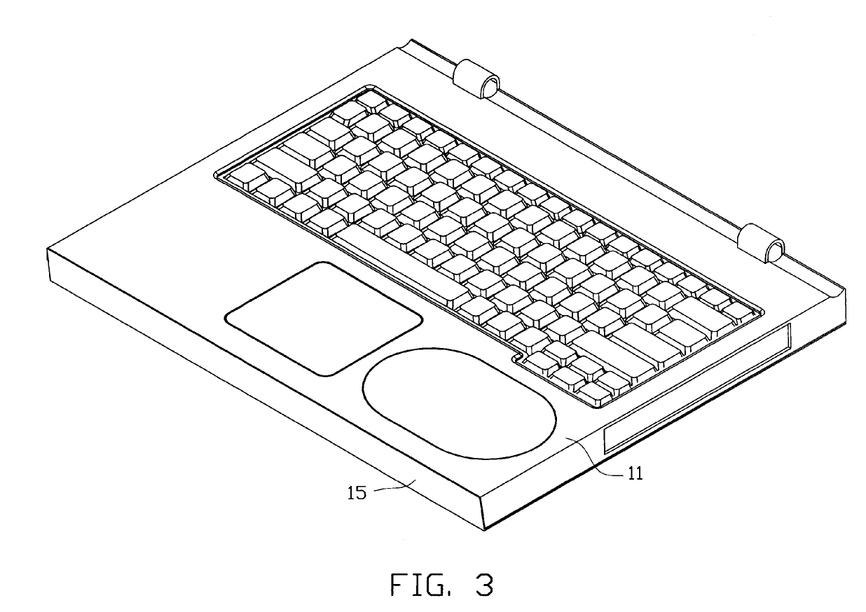

As shown in FIGS. 2 to 4, in assembly, a plurality of screws 17 extends through the through holes 131 of the motherboard 13 to engage in the threaded holes 116 of the positioning posts 115, thus the motherboard 13 is attached to the chassis 11. A plurality of screws 19 extends through the stepped holes 151 of the base 15 and engages in the threaded holes 118 of the retaining posts 117, thus the base 15 fits over the chassis 11 and forms a receiving space. The cover unit 20 is pivotally connected to the rear portion of the base unit 10. FIG. 4 shows an assembled view of the portable computer.

To replace the base 15, the screws 19 are unscrewed, then the base 15 is removed from the base unit 10 freely.

It is believed that the present embodiment and its advantages will be understood from the foregoing description, and it will be apparent that various changes may be made thereto without departing from the spirit and scope of the invention or sacrificing all of its material advantages, the example hereinbefore described merely being a preferred or exemplary embodiment.

What is claimed is:

1. A portable computer comprising:
a base unit comprising a chassis, a motherboard attached to the chassis, and a base engaging with the chassis, the chassis comprising a top plate; and
a cover unit pivotally connected to a rear portion of the base unit and adjacent to the top plate when the portable computer is closed.

2. The portable computer as claimed in claim 1, wherein the motherboard is attached to the top plate.

3. The portable computer as claimed in claim 2, wherein the top plate comprises a plurality of positioning posts extending down therefrom, each of the positioning posts defines a threaded hole, a plurality of through holes is defined in the motherboard, and a plurality of screws extends through the through holes of the motherboard and engages in the threaded holes of the positioning posts respectively.

4. The portable computer as claimed in claim 1, wherein the top plate comprises a plurality of retaining posts, each of the retaining posts defines a threaded hole, a plurality of stepped holes is defined in the base, and a plurality of screws extends through the stepped holes of the base and engages in the threaded holes of the retaining posts respectively.

5. The portable computer as claimed in claim 1, wherein the chassis comprises a side wall extending down from an edge of the top plate, and an access hole is defined in the side wall.

6. The portable computer as claimed in claim 1, wherein the chassis comprises a side wall extending down from an edge of the top plate, and an opening is defined in the side wall.

7. A portable computer comprising:
a base unit comprising a chassis; the chassis having an input device, a motherboard attached to the chassis, and a base attached to the chassis and forming a receiving space for the motherboard; and
a cover unit pivotally connected to a rear portion of the base unit.

8. The portable computer as claimed in claim 7, wherein the chassis comprises a top plate, the top plate is adjacent to the cover unit when the portable computer is closed.

9. The portable computer as claimed in claim 8, wherein the motherboard is attached to the top plate.

10. The portable computer as claimed in claim 9, wherein the top plate comprises a plurality of positioning posts extending down therefrom, each of the positioning posts defines a threaded hole, a plurality of through holes is defined in the motherboard, and a plurality of screws extends through the through holes of the motherboard and engages in the threaded holes of the positioning posts respectively.

11. The portable computer as claimed in claim 8, wherein the top plate comprises a plurality of retaining posts, each of the retaining posts forms a threaded hole, a plurality of stepped holes is defined in the base, and a plurality of screws extends through the stepped holes of the base and engages in the threaded holes of the retaining posts respectively.

12. The portable computer as claimed in claim 8, wherein the chassis comprises a side wall extending down from an edge of the top plate, and an access hole is defined in the side wall.

13. The portable computer as claimed in claim 8, wherein the chassis comprises a side wall extending down from an edge of the top plate, and an opening is defined in the side wall.

14. The portable computer as claimed in claim 7, wherein the input device is a keyboard.

15. The portable computer as claimed in claim 7, wherein the input device is a touchpad.
